(19) United States
(12) Patent Application Publication
(10) Pub. No.: US 2003/0023870 A1
(43) Pub. Date: Jan. 30, 2003

(54) Secure delivery system

(76) Inventor: Darren Matthew Geros, Narrabeen (AU)

Correspondence Address: Edward M Weisz, Cohen Pontani Lieberman & Pavane, Suite 1210, 551 Fifth Avenue, New York, NY, 10176, US

(21) Appl. No.: 10/049,538

(22) PCT Filed: Dec. 22, 2000
(86) PCT No.: PCT/AU00/01586

(30) Foreign Application Priority Data
Dec. 24, 1999 (AU) PQ 4889
Mar. 10, 2000 (AU) PQ 6168

(51) Int. Cl. H04L 9/32

(52) U.S. Cl. 713/200; 705/26

(57) ABSTRACT

A delivery box and associated delivery system including a locking device to govern access to the delivery box; the locking device being linked to a communication device to facilitate remote unlocking of the box; an input device in the nature of the keypad or card reader adapted to receive coded data; a modem associated with the delivery box adapted to receive and transmit data; the modem being interfaced with the input device so as to be capable of transmitting to a remote location; a remote service provider having the facility to generate unique delivery codes in response to requests from retailers and/or consumers; the service provider having the capability of remotely unlocking the delivery box in response to input to the delivery box via the input device of a correct unique delivery code and transmission of that unique delivery code to the service provider via the modem in the delivery box.

### FIELD OF INVENTION

The present invention relates to a secure delivery system for mail, packages and articles as well as apparatus necessary to perform such secure delivery system.

### BACKGROUND OF INVENTION

For many years mail has been utilised to deliver letters, documents and packages although there is general recognition in more recent times that this system is only capable of providing very low security. To this end insured mail deliveries and various forms of certified mail delivery with signatures required from the addressee have been devised although the system still lacks the security necessary in the modern age. Courier deliveries have become more popular and generally a signature is required in order to accept a courier delivery. Where the addressee is a home address however a signature can often not be obtained having regard to the fact that many households now contain two working partners who are away from the premises during daylight and hence most business hours.

The advent of E-commerce has further accentuated the poor security associated with existing mail delivery systems and has inhibited the growth of E-commerce. The nature of E-commerce is that a product may be purchased over the worldwide web but the product must still be physically delivered to the addressee. It is essential to the E-commerce merchant that receipt of the contracted articles can be confirmed. Due to the abovementioned limitations of courier mail deliveries particularly to residential addresses such confirmation is not always possible. If a signature is required for the delivery and the premises is unattended then additional cost is incurred whilst trying to effect delivery at a alternative time. Signatures are also open to fraudulent manipulation particularly as the delivery person often has no signature with which to compare the signature which he or she may receive when delivering an article.

### OBJECT OF INVENTION

It is consequently an object of the present invention to provide a delivery system and associated apparatus which ameliorates one or more of the abovementioned security difficulties with existing systems or at least provides the market with an alternative.

### SUMMARY OF INVENTION

According to the present invention there is disclosed a delivery system involving addressors, addressees and a service provide wherein the addressees are provided with a normally locked delivery box which delivery box is provided with an input device as well as communication means capable of transmitting messages from the input device to the service provider and also capable of receiving an unlock command from a service provider, a unique identifier associated with each addressee's delivery box; microprocessor and electronic storage means associated with a service provider remote from the delivery box and linked to communication means; means accessible to the addressor adapted to generate a code unique to each delivery intended to be effected by that addressor through the system; the delivery box input device being capable of accepting a unique delivery code from a delivery person and in conjunction with the communication means transmitting same to the service provider for verification; reconciliation means associated with the microprocessor and electronic storage means of the service provider for verifying the authenticity of unique delivery codes received from particular delivery boxes; an electronically operable lock on the delivery box interfaced with the communication means of the delivery box such that a service provider may unlock the relevant box by transmission of a signal via the communication means to an individual delivery box in response to receipt of a correct unique delivery code received by the service provider from that box; means associated with the service provider's communication and storage means for recording the fact that a particular unique code has been utilised to open a particular delivery box.

According to another aspect of the present invention there is disclosed a lockable delivery box adapted to be placed in an accessible position; a locking device to govern access to the delivery box adapted for electronic control; an input device adapted to receive coded data; communication means associated with the delivery box adapted to receive and transmit data; the communication means being interfaced with the input device so as to be capable of transmitting coded information from the input device to a remote location; the communication means being interfaced with the electronic locking device such that receipt via the communication means of an appropriate signal from a remote location may effect unlocking of the box.

### BRIEF DESCRIPTION OF DIAGRAMS

Two embodiments of the present invention will now be describe with reference to the accompanying flow charts wherein:

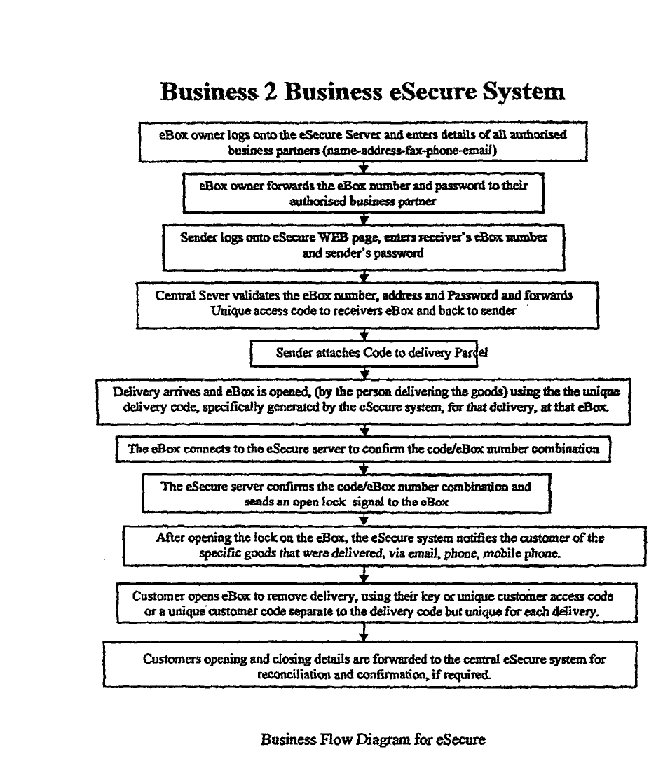

FIG. 1 is a flow diagram indicating the step necessary to be taken by addressors, addressees and service providers in the case where both the addressor and the addressee are businesses seeking to deliver letters or other objects to each other in a secure manner and

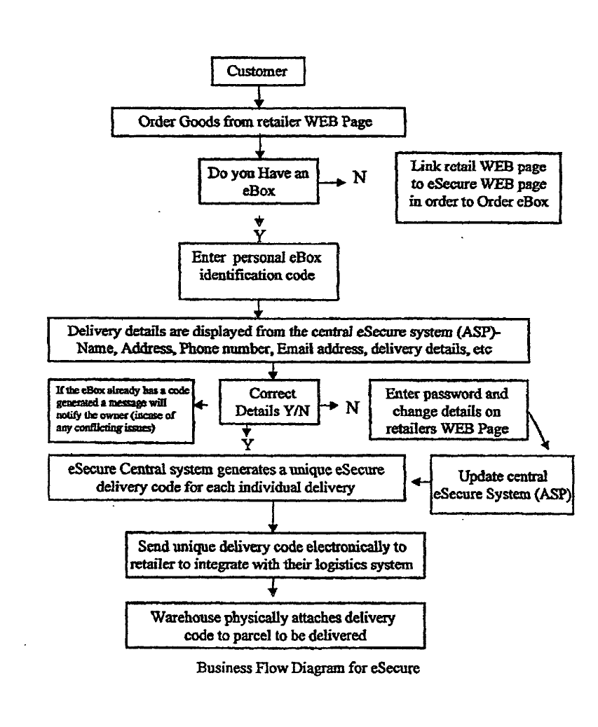

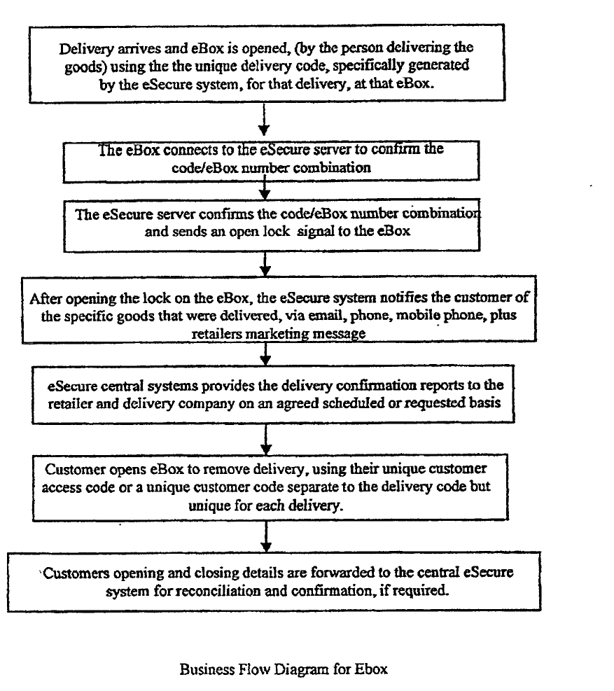

FIGS. 2 and 3 are flow charts indicating the steps which need to be taken to effect a secure delivery in accordance with the present invention as between a customer and a retailer.

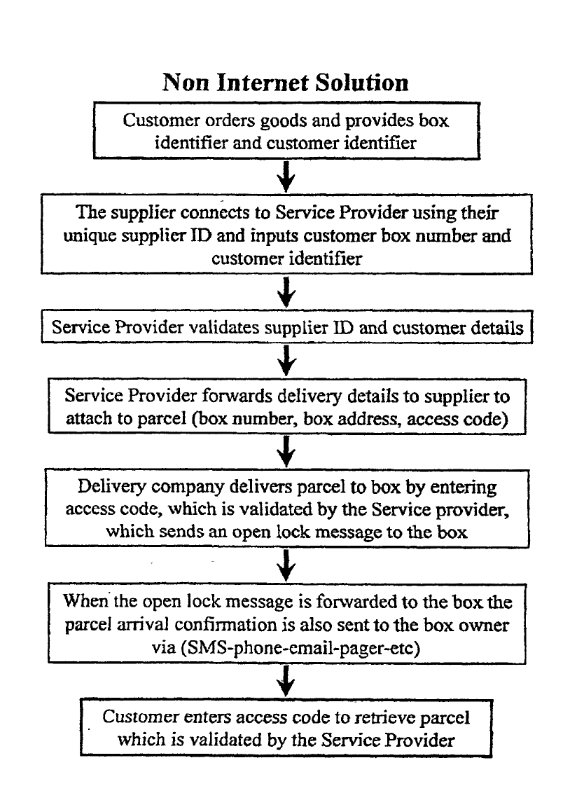

FIG. 4 is a flow chart indicating the steps which may occur when utilising a system in accordance with the preset invention in connection with goods which are not purchased over the Internet; situation a garage, dwelling, office or even back yard may serve as the “box” although of course the input means and communication means would then be interfaced with the lock associated with the dwelling or office door, garage door or gate rather than that of a liter box.

The term “delivery box” where used hereafter should therefore be construed as incorporating a virtual delivery box so as to include such secure areas as lastmentioned.

The box is however biased to a locked state and is provided with communication means which will usually comprise a telephone line. Alternatively wireless communication may be provided. The communication device is associated with an input device so that direct communication is possible between the input device and a remote service provider. The communication device associated with the box is also interfaced with an electronic lock associated with the box in order that the box may receive commands from the service provider (and possibly other remote locations) instructing the lock to deactivate so as to permit access to the box. The electronic lock may be powered by battery or alternatively any other power source.

With reference now to the embodiment to which FIG. 2 applies it will be appreciated that the addressor is a retailer, the addressee is a customer of that retailer and there is also a service provider interposed between these two parties.

In the case of a purchase by the customer from the retailer utilising for example the Internet a customer would order goods via a web page from the retailer. In some cases the retailer's web page could be accessed via the service provider's web page in order that the consumer may be confident that secure delivery in accordance with the preset invention will be available or alternatively the customer may go directly to the web page of a retailer who the customer knows has access to the secure delivery system.

When the customer provides his identification code to the retailer the retailer is able to access the service provider's data base in order to ascertain the relevant delivery address and possibly other details associated with the consumer in order to confirm that the consumer is indeed a box holder.

When the retailer has checked that the consumer is indeed a box holder associated with the system the service provider's computer, upon the request of the retailer, generates a unique delivery code associated with a particular purchase transaction which has been entered into between the customer and the retailer. This unique delivery code is sent electronically to the retailer by the service provider and the retailer ensures that this delivery code is attached in some way to the item to be delivered at the relevant warehousing facility.

The delivery person is instructed to go to the address at which the customer's box is located and upon arriving at the box inputs the delivery code to that box. This may be by way of wiping a bar code or physically inputting numbers into a keypad or otherwise. This keypad or other input device has a direct communication link to the service provider's computer. The service provider's computer then determines whether or not the box from which the transmission is coming is the correct box associated with the delivery code and if it is indeed the correct box then the service provider's computer system causes a coded message to be sent to that box which message deactivates the lock on that box so as to permit access to the box. The delivery is therefore capable of being completed by the delivery person.

The customer subsequently opens their box to remove the delivery utilising their own unique customer access code applicable to their box. The service provider will normally not allow multiple accessing of a box in response to one unique delivery code.

The communication means associated with the box are capable of transmitting to the service provider a record of each time the box is opened by the customer in response to a unique customer code or auxiliary accessing means such as a key and the code which was utilised to open the box. In this way the service provider can confirm when a delivery is made and also if necessary when a delivery is actually removed from the box by a customer. These details or selected parts of these details may then be forwarded to the retailer and/or customer in order to confirm that the delivery has taken place.

With reference now to FIG. 2 there is disclosed a variation of the steps necessary to achieve a secure delivery which variation is more applicable to a business to business situation.

In the case of a purchase by the consumer from a retailer which is not effected over the Internet, for example in the case where the retailer is a mail order company, a customer needs to send the retailer an order form or other communication which includes their unique customer identification code and the identifier associated with their lockable box in accordance with the present invention. Once the retailer has this information the retailer is in a position to create a unique code associated with a delivery on behalf of the secure box owner and the remainder of the process is consequently the same as if the delivery of goods was initiated via the Internet as described herein. A sequence of events which may occur in connection with such non-Internet generated deliveries is set out in FIG. 4 hereof.

A system in accordance with the present invention is needs to provide for return of unwanted, damaged or otherwise inappropriate ps from a box holder or alternatively delivery of articles to locations remote from a box which deliveries commence at a box in accordance with the present invention.

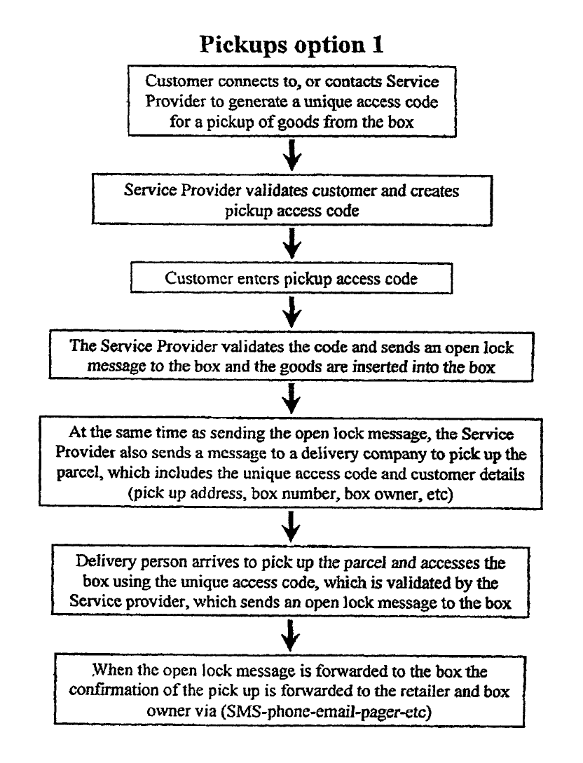

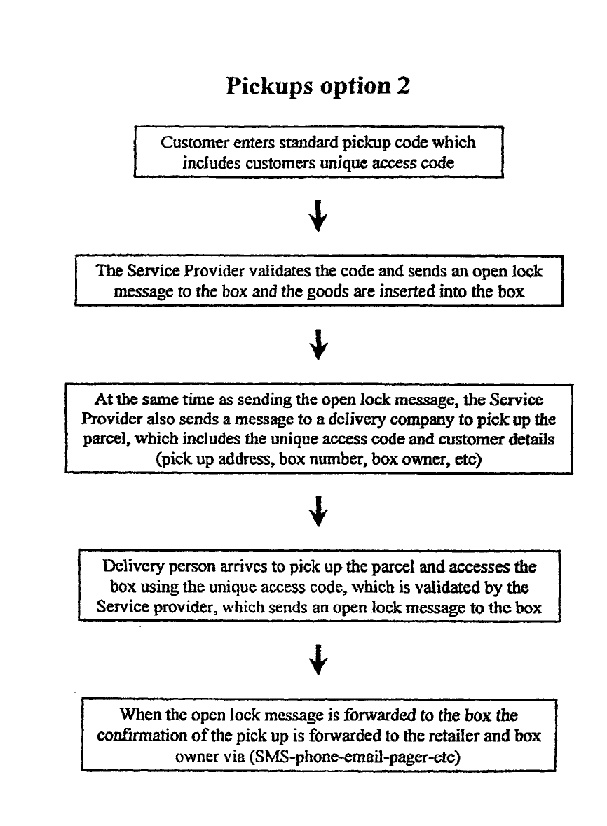

In the case of a parcel needing to be returned to a retailer a customer holding a box in accordance with the present invention would enter a return code or pick-up code into the input device associated with his box followed by or preceded by the customer identifier and a unique access code. This unique access code would usually be the code from the original delivery which would be transmitted to the service provider to authorise the opening of the box upon the delivery person coming to redeem the unwanted goods to be returned. Two flow charts indicating the manner in which such pickups could be achieved in accordance with the present invention are set out in FIGS. 5 and 6 hereof. Essentially the difference between the pick-up option one described in FIG. 5 and the pickup option two described in FIG. 6 is that in pick-up option one the customer contacts the service provider via a computer or otherwise whereas in the example of FIG. 6 pick-up option two provides for the automation of the pick-up process by means of the input device and software included in the delivery box. It will be appreciated that automation of the process is relatively simple as all addresses and other relevant inflation will already be contained within the service provider's data base.

It will be appreciated that a delivery system in accordance with the present invention need not be restricted to instances where box holders permanently own boxes associated with their premises. A system in accordance with the present invention can be adapted so as to cover situations where persons rent or lease boxes on a temporary basis. This temporary basis may be for any time period or alternatively may be limited by reference to the number of secure deliveries which the lessee requires. In many cases a lessee may only require a box in order to achieve one secure delivery.

In such situations a person may lease one or more of a bank of secure delivery boxes all contained at a central location and available for lease from an intermediary controlling the bank of secure delivery boxes at that location.

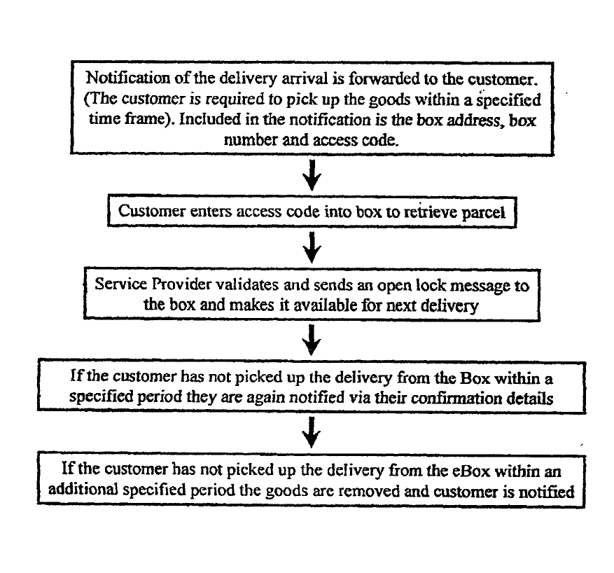

If a customer ordering goods from a retailer for secure delivery to a secure box which is to be rented by that customer for that particular delivery does not have an identification code then a retailer could refer the customer to a relevant intermediary holding boxes at a location convenient for the customer. The customer could enter their postcode for example and the retailer's system would pass this onto the service provider. The service provider would display one or more of the closest locations whereat intermediaries were available to lease secure boxes and the customer would choose a relevant location. The service provider would request the customer to enter their confirmation details being telephone, e-mail or address or a combination thereof. The service provider would then pass back to the retailer's system the relevant delivery address and a unique delivery code associated with the purchase being made. This unique delivery code would be sent electronically to the retailer by the service provider and the retailer would ensure that the delivery code was attached in some way to the article being delivered. Once the delivery had been executed the service provider would forward the unique access code to the customer for use when picking up the delivery. Once the customer code had been utilised the delivery box could then be made available for use by a different customer for a different delivery. A flow chart setting out the relevant steps which would need to be taken in order to effect such deliveries is set out in FIGS. 7 and 8 hereof under the title “Casual Hire Solution”.

It should be appreciated that delivery boxes may be constructed in various ways in order to accord with the intended location or type of goods being delivered. For example a delivery box may be made to be recessed into brickwork of a building in a high density area or alternatively may be constructed so as to be freestanding as would be a mail box in a typical suburban area. The delivery box may be provided with refrigeration for example if it is intended to receive refrigerated goods. The delivery box may be a virtual box which is incorporated within a front door, garage door or gate. The system of the present invention however is applicable to all such embodiments and particularly the generation of a unique delivery/transaction identifier.

The claims defining the invention are as follows:

1. A delivery system involving addressors, addressees and a service provider wherein the addressees are provided with a normally locked delivery box which delivery box is provided with an input device as well as communication means capable of transmitting messages from the input device to the service provider and also capable of receiving an unlock command from a service provider, a unique identifier associated with each addsee's delivery box; microprocessor and electronic storage means associated with a service provider remote from the delivery box and linked to communication means; means accessible to the addressor adapted to generate a code unique to each delivery intended to be effected by that addressor through the system; the delivery box input device being capable of accepting a unique delivery code from a delivery person and in conjunction with the communication means transmitting same to the service provider for verification; reconciliation means associated with the microprocessor and electronic storage means of the service provider for verifying the authenticity of unique delivery codes received from particular delivery boxes; an electronically operable lock on the delivery box interfaced with the communication means of the delivery box such that a service provider may unlock the relevant box by transmission of a signal via the communication means to an individual delivery box in response to receipt of a correct unique delivery code received by the service provider from that box; means associated with the service provider's communication and storage means for recording the i& that a particular unique code has been utilised to open a particular delivery box.

2. A delivery system in accordance with claim 1 hereof wherein the signal transmitted via the communication device by the service provider to unlock the delivery box is encoded.

3. A delivery system in accordance with claim 1 hereof wherein the code unique to each delivery may not be regenerated by the system in relation to a subsequent delivery until the expiry of a pee determined length of time.

4. A delivery system in accordance with claim 1 hereof wherein the communication means for the service provider's microprocessor and electronic storage means and the delivery box comprise modems in connection with conventional data transmission pathways such as telephone lines.

5. A lockable delivery box adapted to be placed in an accessible position; a locking device adapted for electronic control to govern access to the delivery box; an input device adapted to receive coded data; communication means associated with the delivery box adapted to receive and transmit data; the communication means being interfaced with the input device so as to be capable of transmitting information from the input device to a remote location; the communication means also being interfaced with the electronic locking device such tat receipt via the communication means of an appropriate signal from a remote location may effect unlocking of the box.

6. A delivery box in accordance with claim 5 hereof wherein the delivery box is a virtual box incorporating a secure area behind a door or gate such that the locking device on the or gate becomes the locking device controlling access.

7. A delivery box in accordance with claim 5 hereof wherein the communication means comprises a modem in conjunction with conventional data transmission channels such as telephone lines.

8. A delivery box in accordance with claim 5 hereof wherein the input device is a scanning device.

9. A delivery box in accordance with claim 5 hereof wherein the input device is a keypad.

10. A delivery box in accordance with claim S hereof wherein the input device interfaces the communication device via a microprocessor.

11. A delivery box in accordance with claim 5 hereof wherein the input device is a card reader.
